(19) United States
(12) Patent Application Publication
(10) Pub. No.: US 2020/0141762 A1
(43) Pub. Date: May 7, 2020

(54) LOW COST PRECISION DISPLACEMENT SENSOR

(71) Applicant: NATIONAL TSING HUA UNIVERSITY, HSINCHU (TW)

(72) Inventors: Che-Chih TSAO, HSINCHU (TW); Yi-Chun TSENG, HSINCHU (TW)

(21) Appl. No.: 16/677,174

(22) Filed: Nov. 7, 2019

Related U.S. Application Data
(60) Provisional application No. 62/756,730, filed on Nov. 7, 2018.

(51) Int. Cl. G01D 5/14

(52) U.S. Cl. CPC G01D 5/142

(57) ABSTRACT

This invention describes a small sized precision displacement sensor at sub-micron accuracy level with a cost of a fraction of those of existing commercial devices. The basic concept of the new sensor system is to apply a mechanical mechanism to magnify a sub-micron displacement to be measured by about 100 times so that the magnified displacement becomes within the measurement range of a low cost sensor such as a Hall sensor.

### CROSS-REFERENCE TO RELATED APPLICATION

This application claims the benefit of provisional patent application Ser. No. 62/756,730, filed on Nov. 7, 2018, by the present inventors, which is incorporated by reference in its entirety.

### BACKGROUND OF THE INVENTION

### 1. Field of the Invention

The present invention relates to a precision micro-displacement sensor of compact, small characteristic size, simple construction and low cost.

### 2. Background

Precision displacement sensors or gauges are useful in measurements and checking of dimensions of manufactured parts, positions of machine stages, assembly precisions of components in a machine system and in other areas. Traditional mechanical displacement gauges such as dial indicator or meter based on gears and spiral spring have a precision of about 2 μm (micron, or micro meter) and are not suitable for readings resolved down to sub-micron level. Although highly precise displacement measurement systems such as interferometers can easily make sub-micron measurements, they are extremely expensive and bulky and generally not suitable for in-process or in-machine applications. For in-process, in-machine precision measurements, there are several existing devices available for use, as shown in the table of FIG. 1. Among these devices, capacitive sensor, eddy current sensor and digital contact sensor (from Keyence, a contact-type mechanical sensor with a built-in digital optical sensor) can reach 1 micron accuracy and sub-micron resolution. But they are still expensive. The table shows the price of a single sensor head in USD.

If a small sized displacement sensor of comparable precision and resolution can be obtained at a cost of an order of magnitude less, then it can be applied in many situations in large quantities in field. For example, a machine tool or a positioning stage can have several sensors installed at strategic locations and combined measurement results can be used to track machine deformations or position errors in multiple directions due to thermal or load effects in real time. Such information can lead to further improvement of process accuracy. This present invention describes a small sized precision displacement sensor at sub-micron accuracy level with a cost of a fraction of those of existing commercial devices.

### SUMMARY OF THE INVENTION

This present invention describes a precision contact displacement sensing device for measuring a micro-displacement of a target surface with a measurement range from a few micrometers to hundreds of micrometers and a measurement resolution on the order of 0.01 to 1 micrometer and a measurement accuracy of similar order of magnitude. The basic concept is to apply a mechanical mechanism to magnify a sub-micron displacement to be measured by about 100 times so that the magnified displacement becomes within the measurement range of an existing low cost displacement sensor. By making a mechanical mechanism capable of maintaining its magnification ratio with reasonable repeatability, the low-cost displacement sensor, in combination with the mechanical mechanism, can measure the micro-displacement to about 1/100th of its own resolution and accuracy.

Based on the above concept, the precision contact displacement sensing device comprises a displacement magnifying mechanism for magnifying the micro-displacement. The displacement magnifying mechanism comprises an integral structure mounted on a base. The integral structure is capable of elastic deformation and has a geometric layout such that when a contact force, or a change of contact force, is exerted to one position (called contact position thereafter for convenience) on the integral structure the structure deforms elastically and results in a displacement of the contact position as well as a displacement of another position (called measurement position thereafter) on the integral structure and magnitude of the displacement of the measurement position is equal to magnitude of the displacement of the contact position multiplied by a magnification ratio, which is designed to be on the order of about 100.

The precision contact displacement sensing device also comprises an artifact (called contact artifact thereafter) in contact with the target surface. The artifact transmits the micro-displacement of the target surface to the contact position on the integral structure in full amount. That is, the displacement of the contact position is equal to the micro-displacement to be measured. As a result, the magnitude of the displacement of the measurement position, due to the magnification of the deformation of the integral structure, is a magnification of the magnitude of the micro-displacement by the designed magnification ratio. In other words, the micro-displacement to be measured is magnified by a factor of about 100 at the measurement position, assuming the magnification ratio is set to be about 100.

The displacement magnifying mechanism also comprises a non-contact displacement sensor unit, mounted to the same base as the integral structure, for measuring the magnified displacement at the measurement position. Because the micro-displacement is magnified by a factor of about 100, the scale of the magnified displacement is now between 0.1 to 100 mm and the accuracy/resolution is between 1 to 100 micrometer. This range of accuracy and resolution can be achieved by a low cost displacement sensor, such as a Hall effect sensor. Thus, the combination of a low cost displacement sensor with the mechanical displacement magnifying mechanism enables the low cost displacement sensor to measure micro-displacements with sub-micrometer resolution and accuracy.

The integral structure can be a structure fabricated from a monolithic piece of solid material or an assembly of parts joined into an integral solid structure. Therefore, there is no mechanical contact with relative motion between any parts of the structure. The magnification is purely due to the geometric layout and the elastic deformation of the structure. This ensures consistency and good repeatability of the magnification mechanism.

One preferred embodiment of the integral structure is a system of lever structures connected in cascaded stages. Each lever structure includes a base frame, an arm (beam) and a flexural hinge connecting the arm to the base frame as fulcrum. Thereby a lever structure is an integral solid structure and the elastic deformation of the flexural hinge allows the lever to move. The base frames are joined together as an integral solid and fixed to the base of the integral structure. The output end (load end) of the arm of one lever structure is connected and coupled to the input end (effect end) of the arm of the lever structure of the next stage by flexural coupler that transmit arm displacement and accommodate relative motion between the two adjacent arms. Therefore, magnified displacement in a lever structure in one stage drives another lever structure in the next stage and is amplified further.

To obtain an overall magnification of about 100, 2 or 3 stages of lever structure can be used. If 2 stages are used, then the magnification ratio of each lever structure can be about 10. If 3 stages are used, then the magnification ratio of each lever structure can be between 4 and 5.

The lever structures can be disposed with one lever structure on top of another and with the planes of motion of the arms all on a same plane. The lever structures can also be disposed side by side with all arms in parallel and with the plane of motion of each arm different but parallel to each other. In order to have a compact form factor and small characteristic size, it is preferred to align adjacent lever structures with the output ends of the arms pointing to opposite directions. When the lever structures are arranged side by side, it is preferred for the flexural coupler have two perpendicular flexural sections, one for accommodating relative rotations and one for minute relative translations between two adjacent arms.

In order to minimize loss of magnification and to maximize displacement transmission efficiency, it is preferred to arrange the geometric layout of the integral structure such that the direction of the contact force results in mainly bending and/or tension in the flexural hinges and the flexural couplers during operation and avoid possible compression or shearing forces perpendicular to the axes of rotation of the flexural sections of these flexural connecting parts. This also helps maintaining repeatability of the functions of the mechanism.

Another embodiment of the integral structure is a system of bridge-type mechanical amplifiers connected in cascaded stages. A bridge-type mechanical amplifier includes a pair of bridge structures. Each bridge structure includes a rigid middle section with two flexural foils attached at two sides at an angle, forming a basic bridge geometric. To rigid end sections are attached to the two ends of the bridge geometric. The two bridge structures are joined in a symmetric form with the two end sections of one bridge structure attached to the two end sections of the other bridge structure, with the arch spaces of the bridges in between. Preferably, one bridge structure of the pair is fixed to the base at its middle section and an input force (displacement) acts on the inner side of the middle section of the other bridge structure, creating tensions in the structures, for reasons described previously. The output end is on one of the two joined end sections. For transmitting a displacement from one stage to the next stage, a flexural coupler connects the output end to the input middle section. In the bridge-type mechanical amplifier, the motion direction of the input is perpendicular to that of the output. Therefore, the amplifiers of adjacent stages are also disposed in perpendicular directions with an output end of one stage pointing to the input middle section of the next stage.

The contact artifact can be an object of high hardness with a pointing profile. A fabricated ball of zirconia, ruby, or alumina can be used. The ball can be fixed to the contact position on the integral structure directly.

When the target surface is moving relative to the micro-displacement sensing device with its major motion in directions perpendicular to the direction of motion of the micro-displacement of the contact point between the contact artifact and the target surface, it is preferred to provide a mechanism to avoid possible effects of the major motion to the magnification mechanism. Therefore, a contact relay mechanism can be applied to ensure that the contact point only moves in the designed direction. The contact artifact can be set on a hard seat at the unsupported end of a thin but wide flexural cantilever beam so that the contact artifact basically can only move in direction of deflection of the cantilever beam. A second contact artifact is fixed to the contact position on the integral structure directly. The flexural cantilever beam can be fixed to a casing, which is attached to the base, and the hard seat can be brought in contact with the second contact artifact with a slight preload so that the target surface, the first artifact with the hard seat and the second contact artifact are always kept in contact. This way, the micro-displacement of the target surface can be transmitted fully to the contact position on the integral structure.

A preferred sensor unit includes a Hall sensor on the base and a magnet on the measurement position of the integral structure facing the sensing surface of the Hall sensor.

The sensing device also includes a casing covering the magnifying mechanism and the sensor unit for protection purpose.

According to above contents, the system of the present invention can have at least one of the following advantages: low cost, compact, precision as commercial micro-displacement sensors, being able to output an electrical signal and easy to be applied for control and monitoring purpose.

### BRIEF DESCRIPTION OF THE DRAWINGS

The structure, operating principle and effects of the present invention are described in details by the following drawings.

FIG. 1 is a comparison of commercially available micro-displacement sensors in performances and prices.

FIG. 2 explains the basic principle of the present invention with specific dimensional numbers as an example.

FIG. 3 depicts an example of a single lever structure according to an embodiment of the present invention.

FIG. 4 shows a typical flexural bearing in integral form (monolithic form).

FIG. 5 explains the assembly of a displacement magnifying mechanism of 3 stages of lever structure in exploded view according to an embodiment of the present invention.

FIG. 6 depicts an assembled displacement magnifying mechanism of 3 stages of lever structure according to an embodiment of the present invention.

FIG. 7 depicts a full assembly of the low-cost micro-displacement sensor including a displacement magnifying mechanism based on 3 stages of lever structure and a Hall sensor.

FIG. 8 depicts the arrangement of a contact artifact mounted directly to the contact position of the integral structure and the opening on the device casing with a sealing film in sectional view from the side according to an embodiment of the present invention.

FIG. 9 depicts an assembled displacement magnifying mechanism of 2 stages of lever structure with a Hall sensor according to an embodiment of the present invention.

FIG. 10 depicts a contact relay mechanism in sectional view from the side according to an embodiment of the present invention.

FIG. 11 depicts an assembled displacement magnifying mechanism of 2 stages of bridge-type mechanical amplifier with a Hall sensor according to an embodiment of the present invention.

FIGS. 12 (a) and 12(b) show example prototypes according to embodiments of the present invention. FIG. 12 (c) shows measurement results.

### DETAILED DESCRIPTION OF THE PREFERRED EMBODIMENTS

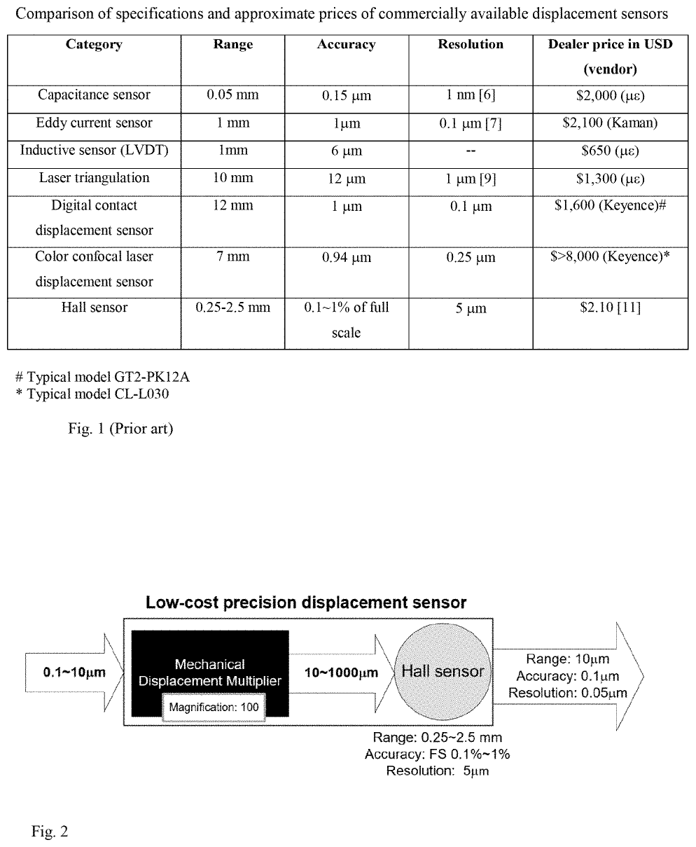

From FIG. 1, we see that Hall sensor has a significantly low cost but with a measurement resolution of about 5 μm. It has an accuracy of about 0.1-1% of full scale and a range of 0.25-2.5 mm. That is, for a measurement range on the order of 1000 μm and a resolution/accuracy of 1-5 μm, Hall sensor is a very cost effective choice. Now, for measuring a displacement down to 0.1 μm, if we can magnify this tiny displacement by a factor of, say, 100 then we'll be measuring 10 μm, which falls well within Hall sensor's capability. That is, if a magnification mechanism can be devised to reliably magnify sub-micron displacements with good repeatability, then a Hall sensor can be used to resolve a micro-displacement of 0.1 μm with a full range of 10 μm, while the Hall sensor itself is measuring displacements in a full range of 1 mm with a resolution of 10 μm. The idea is shown in FIG. 2. Such a mechanical magnification mechanism can be made small with low cost and, combined with a Hall sensor, or other sensor capable of similar measurement range and accuracy and resolution, a low cost precision displacement sensor can be made.

One preferred embodiment of the mechanical displacement magnifying mechanism features an integral structure of lever structures connected in cascaded stages. Magnified displacement in a lever structure in one stage drives another lever structure in the next stage and is amplified further.

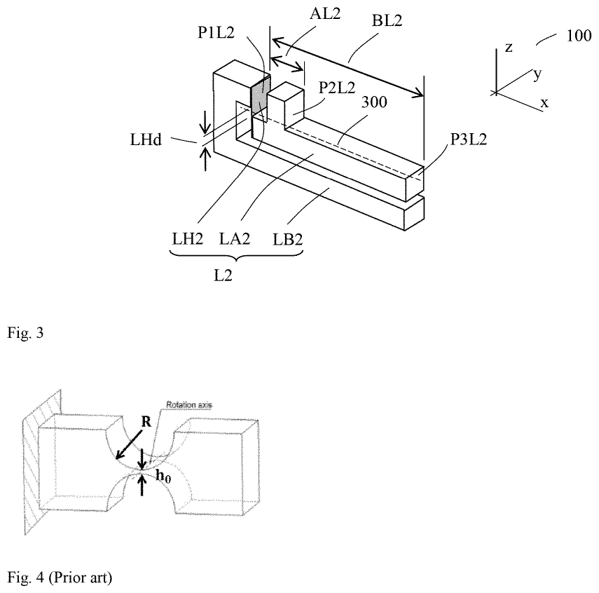

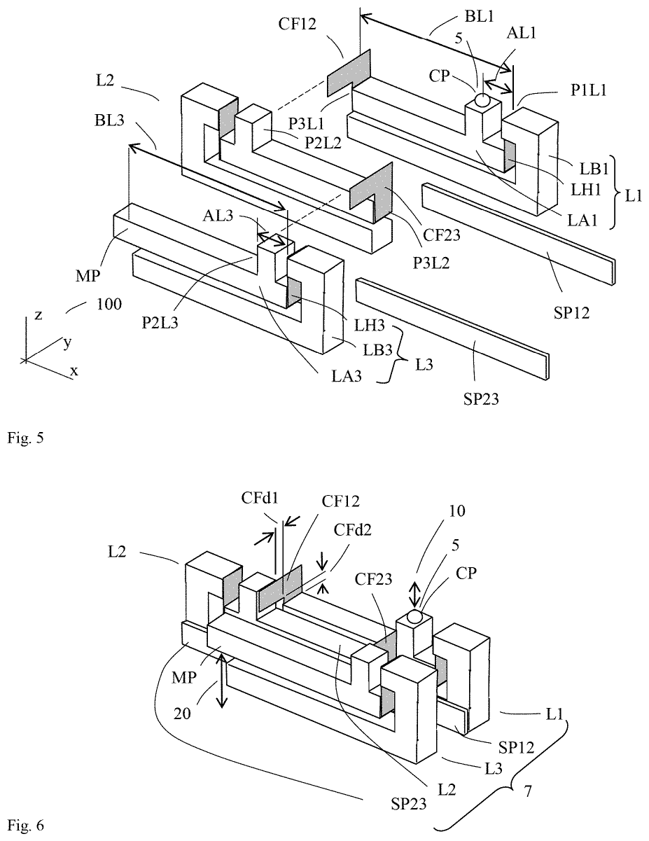

FIG. 3 depicts an example of a single lever structure, which includes a base frame LB2, an arm (beam) LA2 and a hinge LH2 that connects the arm to the base frame. For convenience of later description, this lever structure is referred to as the 2nd lever L2. In a practical implementation, the base frame and the arm can be made of a metal or any other sturdy material. The hinge can be in the form of a foil spring, such as a spring steel foil, as illustrated in FIG. 3. The foil spring is attached to a base mounting face P1L2 on the base frame and to one end of the arm. The amounting can be by screw or by joining such as brazing or soldering or glue. A small section of the foil spring (LHd) is left “bare”, that is, without contact to either the arm or the base frame, in order to facilitate the hinge function. The arm and the base frame can also be made from a single piece of material with a flexural joint in between as the hinge in integral form. FIG. 4 shows a typical flexural joint in integral form, which is also called a monolithic flexural joint or bearing in industry. The principle of flexural bearing or joint in monolithic form or foil spring form (or called clamped flat spring) can be seen in Slocum, A. H., Precision Machine Design, Prentice Hall, N.J., 1992, Chapter 8, section 8.6, which is incorporated herein by reference. By either way, the lever structure is made into an integral body with no sliding contact and the arm rotates only by elastic bending of the hinge. The arm includes a protruded feature with a second mounting face P2L2, which is parallel to the first mounting surface P1L2. When the protruded feature on the arm is pushed downward (i.e., toward −z direction, referring to coordinate frame 100), downward displacement at the second mounting face P2L2 is amplified at the end of the arm at a third mounting face P3L2 by a factor of BL2/AL2, the ratio of the distances from the third mounting face P3L2 and the second mounting face P2L2 to the base mounting face P1L2.

To magnify a tiny displacement by two orders of magnitude, 2 or 3 stages of lever structure are connected in cascade side by side in parallel orientations by using a flexural coupling foil (that is, the flexural coupler) between adjacent lever structures. FIG. 5 explains the assembly of a magnification mechanism of 3 stages of lever structure in exploded view. The 3 lever structures are of basically similar configuration as the one depicted in FIG. 3. In this example, the lever structures are disposed side by side with all arms in parallel and with the plane of motion of each arm different but parallel to each other. The first stage lever L1 includes a base frame LB1, an arm LA1 and a hinge LH1. The arm L1 also has a protruded feature as the contact position CP, onto which a ball, for example, made of Zircon, is mounted as the contact artifact 5 as the input point. The magnification ratio from the contact position CP to the end of the arm P3L1 is BL1/AL1. In FIG. 5, lever L1 is oriented with the end P3L1 of the arm LA1 pointing to −x direction.

The second stage lever, L2, already described with FIG. 3, is placed in parallel relative to lever L1 but oriented with its end of arm P3L2 pointing toward +x direction. That is, in order to have a compact form factor and small characteristic size, adjacent lever structures are aligned with the output ends of the arms pointing to opposite directions. Further, the second mounting face P2L2 of the arm LA2 is aligned to the end face P3L1 of the arm LA1 such that a flexural foil CF12 couples lever L1 and lever L2 at the two faces. The lower portion of the “Γ”-shaped foil is mounted to the arm LA1 at its end face P3L1 and part of the upper portion is mounted to the second mounting face P2L2 of the lever L2. Thus, the displacement at the end of the arm LA1 can be transmitted to lever L2.

The third stage lever, L3, is basically similar to lever L1, with a base frame LB3, an arm LA3 and a hinge LH3. Lever L3 is oriented with its end of arm pointing toward −x direction. The arm LA3 also has a protruded feature with a second mounting face P2L3, which is aligned to the end face P3L2 of the arm LA2. Similarly, the lower portion of a “Γ”-shaped foil flexural foil CF23 is mounted to the arm LA2 at its end face P3L2 and part of the foil's upper portion is mounted to the second mounting face P3L2 of the lever L2. Thus, the displacement at the end of the arm LA2 can be transmitted to lever L3. The magnification ratio from position P3L2 to a measurement position MP near the end of the arm LA3 is BL3/AL3.

The 3 lever structures are assembled side by side together with a spacer stripe (SP12 and SP23) between adjacent lever structures to prevent unwanted sliding contact between the arms. FIG. 6 depicts the assembled magnifying mechanism of the 3 stages of lever structure. The 3 cascaded lever structures constitute the integral structure 7 capable of elastic deformation as described in Summary of the Invention. The contact artifact 5, a contact ball in this case, is set to the contact position on lever L1 directly. A tiny displacement at the contact position CP is magnified at the measurement position MP by a cascaded ratio of:

Total theoretical magnification=(BL1/AL1)(BL2/AL2)(BL3/AL3)

Arrows 10 and 20 indicate directions of the input micro-displacement and of the output magnified displacement of the assembly respectively. Assuming the magnification of each lever structure is 5, the total theoretical magnification is then 125, two orders of magnitude amplification.

In order to achieve good results, all arms should be of lightweight construction. Dimensions of all hinges should be made to have maximum stresses within endurance limit in the full operation range of the system. Each coupling foil (CF12 and CF23) should be mounted with two “bare” sections, that is, without any other material or structure one either side of the sections. As depicted in FIG. 6, on coupling foil CF12, a horizontal bare section CFd2 above lever L1 and a vertical bare section CFd1 to the side of lever L2. Same for coupling foil CF23 (details not shown). The reason for this feature is that there are not only rotational relative motions between adjacent arms but also small linear relative motions when the magnifying mechanism operates. These bare sections can accommodate these relative motions and facilitate motion transmission from one stage to the next.

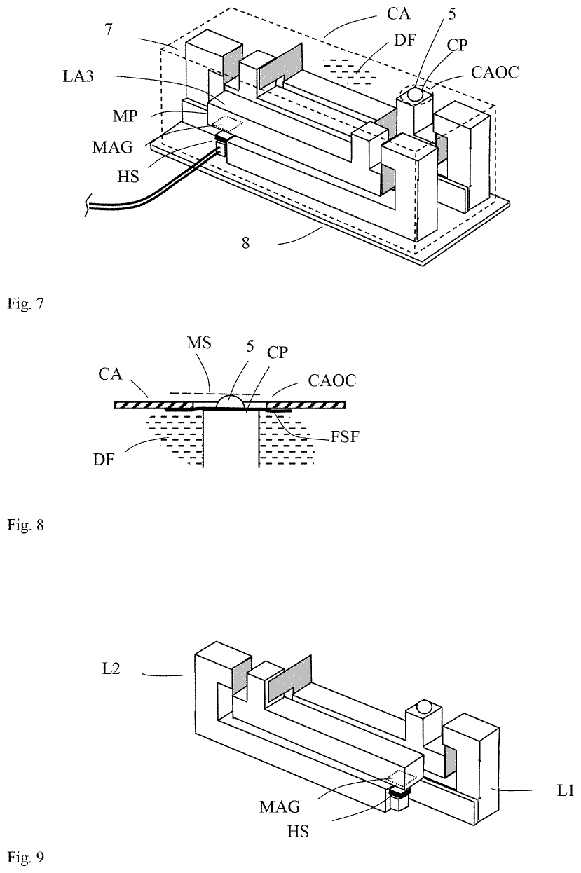

The magnified displacement at MP can then be measured by a Hall sensor HS. FIG. 7 depicts a full assembly of the low-cost micro-displacement sensor based on the displacement magnifying mechanism applying cascaded lever structure and a Hall sensor. The displacement magnifying mechanism 7 is mounted to the base 8. The Hall sensor HS is also fixed to the base 8. The magnet pad MAG is attached to the bottom of the arm LA3. The assembly is packaged within a casing CA.

Because the contact artifact 5 at the contact position CP must be exposed above the casing, an opening configuration CAOC as shown in FIG. 8, in sectional view, can be applied. A thin soft film FSF, of polymer for example, glued to the peripheral of the ball and the rim of the opening hole can act as a membrane seal with minimum effect to the responsive force of the displacement sensor at contact position CP. MS indicate the target surface, of which displacement is to be measured, in contact with the ball.

The interior of the casing can contain a dampening fluid DF, in case the lever structures, especially the last stage (e.g. L3), become sensitive to vibration caused by external effects other than displacement at the contact artifact 5. The dampening fluid can reduce or eliminate these vibration noises.

If lever structures of magnification ratio of 10 are used, then two stages are enough to create 10×10=100 times magnification. FIG. 9 illustrates the idea of a 2-stage system.

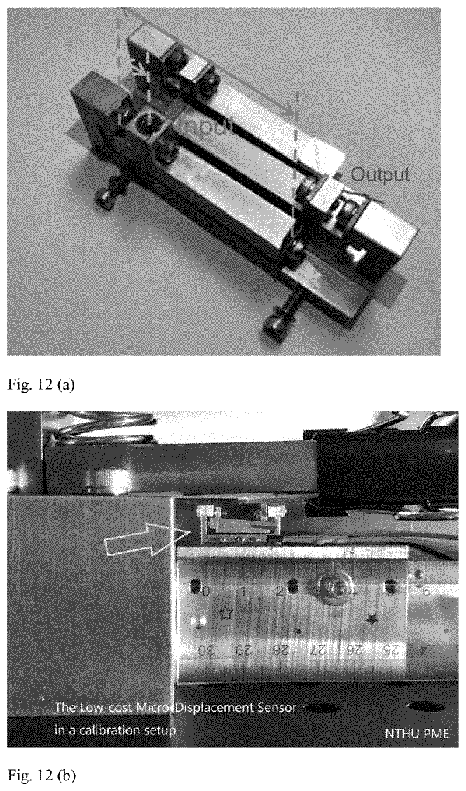

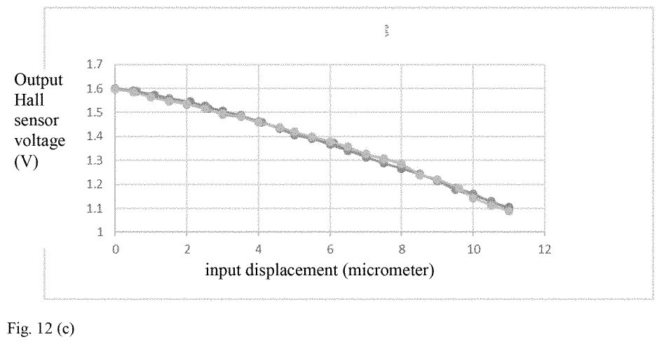

Two prototypes of the low cost micro-displacement sensor were built using lever structure magnifying mechanism of cascaded lever structures made from aluminum and steel foil springs and using Honeywell SS495A Hall sensor with a tape magnet for output reading. FIG. 12 (a) illustrates a 3-stage prototype of about 80 mm long. FIG. 12 (b) illustrates a 2-stage prototype of 20 mm long in a calibration setup. Both having a magnification ratio of about 125. Test measurements were calibrated and compared with results from a precision eddy current sensor. FIG. 12 (c) shows measurement results of the prototype of FIG. 12 (b). Data analysis shows an accuracy of 0.6 micrometer and resolution of 0.1 micrometer.

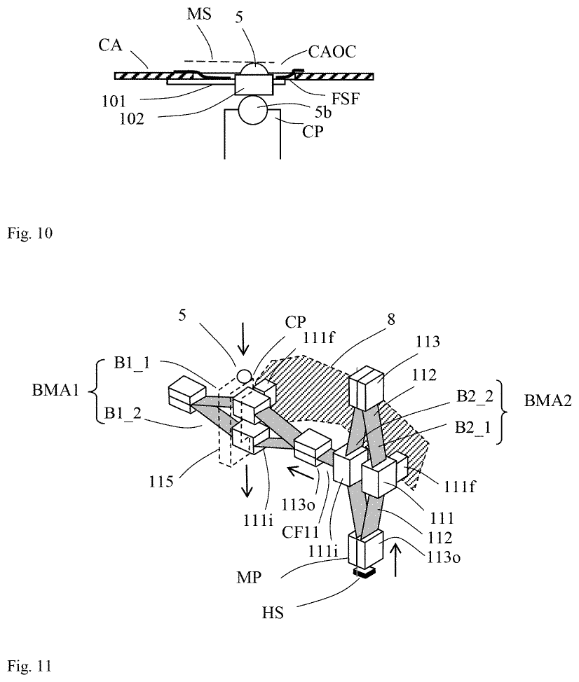

When the target surface is moving relative to the micro-displacement sensing device with its major motion in directions perpendicular to the direction of motion of the micro-displacement of the contact point between the contact artifact and the target surface, it is preferred to provide a mechanism to avoid possible effects of the major motion to the magnification mechanism. FIG. 10 illustrates a contact relay mechanism that can be applied to ensure that the contact point only moves in the designed direction. The contact artifact 5 can be set on a hard seat 102 at the unsupported end of a thin but wide flexural cantilever beam 101 so that the contact artifact basically can only move in direction of deflection of the cantilever beam. A second contact artifact 5b is fixed to the contact position on the integral structure directly. The flexural cantilever beam can be fixed to a casing CA, which is attached to the base 8, and the hard seat 102 can be brought in contact with the second contact artifact 5a with a slight preload so that the target surface, the first artifact with the hard seat and the second contact artifact are always kept in contact. This way, the micro-displacement of the target surface can be transmitted fully to the contact position on the integral structure.

Although the magnification mechanism described above is an assembly from individual lever structures, the basic concept can also be implemented by making a similar but integral structure of multiple levers by injection molding of one or more polymeric materials.

Another embodiment of the integral structure is a system of bridge-type mechanical amplifiers connected in cascaded stages. The principle of the bridge-type mechanical amplifier can be seen in Juuti et al., “Mechanically amplified large displacement piezoelectric actuators”, Sensors and Actuators A 120 (2005) 225-231, which is herein incorporated by reference. FIG. 11 depicts 2 modified bridge-type mechanical amplifiers connected in cascade. As depicted in FIG. 11, a modified bridge-type mechanical amplifier (BAM2, for example) includes a pair of bridge structures (B2_1 and B2_2). Each bridge structure includes a rigid middle section 111 with two flexural foils 112 attached at two sides at an angle, forming a basic bridge geometric. Two rigid end sections 113 are attached to the two ends of the bridge geometric. The two bridge structures are joined in a symmetric form with the two end sections of one bridge structure attached to the two end sections of the other bridge structure, with the arch spaces of the bridges in between. In the stage 1 bridge-type mechanical amplifier BAM1, one bridge structure of the is fixed to the base 8 at its middle section 111f. The input force (displacement) acts on the other middle section 111i of the other bridge structure, through the contact position CP on a bracket 115. The output end is on one of the two joined end sections 113o. For transmitting a displacement from one stage to the next stage, a flexural coupler CF11 connects the output end 113o to the input middle section 111i of the next stage BAM2. In the bridge-type mechanical amplifier, the motion direction of the input is perpendicular to that of the output. Therefore, the amplifiers of adjacent stages are also disposed in perpendicular directions with an output end of one stage pointing to the input middle section of the next stage.

The present invention disclosed herein has been described by means of specific embodiments. However, numerous modifications, variations and enhancements can be made thereto by those skilled in the art without departing from the spirit and scope of the disclosure set forth in the claims.

For example, although the lever structures described in the examples all have their fulcrum position at one end of the arm (beam), lever structures having the fulcrum positioned between the input end and the output end can also be used and can be cascaded by following the teaching from the above disclosure.

It should also be noted that the magnification ratio of the mechanical magnifying mechanism does not need to be constant over the full measurement range. Therefore, the non-linearity of FIG. 12 (c) does not affect the function of the sensor, as long as the output repeatability corresponding to a fixed input is good.

Because the Hall sensor uses magnetic field for measurement, it is preferred for the casing to contain a magnetic shielding layer to filter out possible externa magnetic disturbances. A “Mu metal” sheet or a sheet of an alloy of nickel, iron and molybdenum can serve the purpose.

What is claimed is:

1. A precision contact displacement sensing device for measuring a micro-displacement of a target surface with a measurement range from a few micrometers to hundreds of micrometers and a measurement resolution on the order of 0.01 to 1 micrometer and a measurement accuracy of similar order of magnitude, the device comprising:
a displacement magnifying mechanism, the mechanism comprising an integral structure mounted on a base, the integral structure being capable of elastic deformation and having a geometric layout such that a displacement at a contact position on the integral structure results in a displacement at a measurement position also on the integral structure and magnitude of the displacement of the measurement position is equal to magnitude of the displacement of the contact position multiplied by a magnification ratio, which is designed to be on the order of about 100;
a contact artifact in contact with the target surface for receiving the micro-displacement of the target surface and transmitting the micro-displacement to the contact position on the integral structure in full amount thereby causing a displacement of the measurement position with a magnitude of equal to magnitude of the micro-displacement multiplied by the magnification ratio;
a non-contact displacement sensor unit for measuring the displacement of the measurement position, the sensor unit having a measurement resolution on the order of 1 to 5 micrometer and a measurement accuracy of 1 to 10 micrometer, the sensor unit being capable of outputting an electric signal correlated to the measured displacement of the measurement position;
wherein a correlation between the micro-displacement and the electrical signal can be obtained by a calibration process and thereby the micro-displacement can be measured by measuring the electrical signal.

2. The device of claim 1, wherein
the displacement magnifying mechanism comprises a system of lever structures connected in cascaded stages as the integral structure, wherein each of the lever structure including a base frame, an arm and a flexural hinge connecting the arm to the base frame as fulcrum, the base frames being joined together as an integral solid and fixed to the base, output end of the arm of one lever structure is connected and coupled to the input end of the arm of the lever structure of the next stage by a flexural coupler that transmits arm displacement and accommodate relative motion between the two adjacent arms;
the contact position being on input end of the lever structure in the first of the cascaded stages and the measurement position being on output end of the lever structure in the last of the cascaded stages;
the non-contact displacement sensor unit comprises a Hall sensor on the base and a magnet on the measurement position.

3. The device of claim 2, wherein
the lever structures being disposed side by side with all the arms in parallel and with the plane of motion of each arm different but parallel to each other;
the adjacent lever structures being aligned with the output ends of the arms pointing to opposite directions;
the flexural coupler comprising two perpendicular flexural sections, one for accommodating relative rotations and one for minute relative translations between two adjacent arms.

4. The device of claim 3, wherein
the geometric layout of the cascaded lever structures resulting in mainly bending and tension in the flexural hinges and the flexural couplers and minimizing compression or shearing forces perpendicular to the axes of rotation of flexural sections of the flexural the flexural hinges and the flexural couplers during operation.

5. The device of claim 3, wherein the contact artifact being disposed on a hard seat on a contact relay mechanism which restricts the contact artifact to move only in directions of the micro-displacement to be measured, the device further comprising a second contact artifact set directly to the contact position, the contact relay mechanism providing a preload for the hard seat to be in contact with the second contact artifact during operation of the device.

6. The device of claim 1, wherein
the displacement magnifying mechanism comprises a system of bridge-type mechanical amplifiers connected in cascaded stages;
the non-contact displacement sensor unit comprises a Hall sensor on the base and a magnet on the measurement position.

7. The device of claim 6, wherein
the geometric layout of the cascaded bridge-type mechanical amplifiers resulting in mainly bending and tension in flexural parts of the amplifiers.
